(19) United States
(12) Patent Application Publication
(10) Pub. No.: US 2017/0260879 A1
(43) Pub. Date: Sep. 14, 2017

(54) METHODS FOR PRODUCING AND STORING ENERGY SOURCES

(71) Applicants: Satish S. Tamhankar, Scotch Plains, NJ (US); Neeraj Saxena, Murray Hill, NJ (US)

(72) Inventors: Satish S. Tamhankar, Scotch Plains, NJ (US); Neeraj Saxena, Murray Hill, NJ (US)

(21) Appl. No.: 15/069,252

(22) Filed: Mar. 14, 2016

(51) Int. Cl. F01K 11/02; F01K 25/00; C01B 3/24; H01M 8/0612

(52) U.S. Cl. CPC F01K 11/02; H01M 8/0618; F01K 25/005; C01B 3/24; H01M 2250/10; C01B 2203/0272; C01B 2203/066; C01B 2203/1241; C01B 2203/84

(57) ABSTRACT

A method for producing an energy source from excess electricity is disclosed. The method uses excess electricity from a power grid when electrical demand is low. The method produces the energy source by performing the steps firstly in the storage phase of feeding the excess electricity to a thermal reactor wherein solid carbon and gaseous hydrogen are produced from the thermal reaction of a hydrocarbon; feeding the gaseous hydrogen to a hydrogen storage unit; feeding the solid carbon to a carbon storage unit; and secondly in the discharge phase, feeding the solid carbon to a combustion unit wherein steam is produced; and feeding the steam to an engine or a turbine thereby producing electricity.

### BACKGROUND OF THE INVENTION

The present invention relates to a method for producing and storing energy sources.

Power production, especially with renewable resources such as solar or wind power is intermittent and may not match user demand in real time. Consequently, there is a need to store energy when it is produced in excess so that it will be available at a later time when demand is higher.

There are a number of energy storage methods that have been developed including batteries, compressed air and hydrogen. Each of these storage solutions has its own advantages and limitations.

Hydrogen is seen as an attractive energy storage medium. Currently, hydrogen is produced by electrolysis using the “excess” energy produced which is stored in the form of hydrogen. When power is needed, hydrogen can be used in a fuel cell device to generate power. However, the round trip efficiency of such a system is low (<25 to 30%). Further, gaseous hydrogen storage with current technologies can be expensive, requiring large spaces and safety and handling issues.

The present invention addresses these shortcomings and provides means to produce carbon during times when electrical demand is low and the electric grid is overproducing electricity. This carbon can be stored and used as an energy source when electric demand is high.

### SUMMARY OF THE INVENTION

In a first embodiment of the invention there is disclosed a method for producing an energy source, such as electricity or solid carbon, using excess electricity from a power grid when electrical demand is low comprising the steps:
a) feeding the excess electricity to a thermal reactor wherein solid carbon and gaseous hydrogen are produced from the thermal reaction of a hydrocarbon:
b) feeding the gaseous hydrogen to a hydrogen storage unit;
c) feeding the solid carbon to a carbon storage unit;
d) feeding the solid carbon to a combustion unit wherein steam is produced; and
e) feeding the steam to an engine or a turbine thereby producing electricity.

In a second embodiment of the invention there is disclosed a method for producing electricity using excess electricity from a power grid when electrical demand is low comprising the steps:
a) feeding the excess electricity to a thermal reactor wherein solid carbon and gaseous hydrogen are produced from the thermal reaction of a hydrocarbon;
b) feeding the gaseous hydrogen to a hydrogen storage unit;
c) feeding the solid carbon to a carbon storage unit;
d) feeding the solid carbon to a combustion unit wherein steam is produced; and
e) feeding the steam to an engine or a turbine thereby producing electricity.

The energy source in this instance is the solid carbon produced. As discussed in steps d) and e) the solid carbon energy source can be combusted to produce electricity.

For purposes of the present invention, the excess electricity from a power grid when electrical demand is low is that amount of electricity produced that is greater than the amount of electricity demand at that time.

The hydrocarbon which is preferably methane is fed to the thermal reactor where it is combusted to produce the solid carbon and gaseous hydrocarbon.

The gaseous hydrogen produced can be compressed before it is fed to the gaseous hydrogen storage. The gaseous hydrogen may be deployed in a method selected from the group consisting of car fueling, pipeline injection, and fuel cell for power generation.

When the gaseous hydrogen is employed for power generation, the electricity that is generated may be fed in a co-generation manner to the electricity that makes up the feed to the thermal reactor.

In the discharge phase of the invention, air, enriched air or oxygen is fed to the combustion unit where it will react with the solid carbon feed in the combustion unit. The combustion unit may be a heat recovery steam generator (HRSG). The by-products of this reaction are steam and carbon dioxide.

The steam may be fed from the combustion unit to an engine. Low pressure steam may be recovered from the turbine or the engine and fed to a second heat recovery steam generator. This second heat recovery steam generator may then produce high pressure steam which may be recovered and fed to the combustion unit for use in further producing steam and carbon dioxide.

### BRIEF DESCRIPTION OF THE DRAWINGS

FIG. 1 is a schematic of a process for producing and storing carbon for the later production of power.

FIG. 2 is a schematic of a process for combusting the stored carbon to produce power.

### DETAILED DESCRIPTION OF THE INVENTION

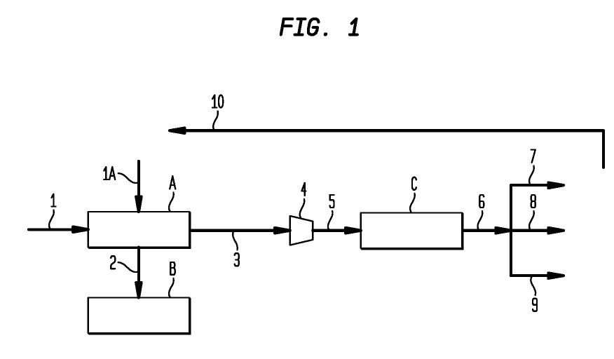

In FIG. 1, there is shown a process for thermally decomposing a hydrocarbon to produce hydrogen and carbon. A feed of excess electricity that is drawn from a power grid during times of lower electrical demand is directed to a thermal reactor A through line 1A. A hydrocarbon such as natural gas is fed through line 1 to a thermal reactor A. This thermal reactor A can be a typical decomposition unit. The hydrocarbon is typically methane gas that has been derived from biomass decomposition or is a waste hydrocarbon stream from various petroleum refinery operations.

The decomposition produce hydrogen which is fed through line 3 to a compressor 44 and into line 5 where it will enter a hydrogen storage container C. The solid carbon that is produced in the decomposition is fed through line 2 to a carbon storage unit B.

The compressed and stored hydrogen can be used as a power source by feeding to one or more intended destinations through line 6 to line 7 for fuel cell for power generation or line 8 for pipeline conversion and/or line 9 for car or other vehicle fueling operation.

Additionally in a co-generation like manner, the hydrogen storage can be partially integrated with the thermal reactor by feeding electricity produced by the hydrogen when used as a feed stock to join with through line 10 the excess electricity feed 1A to the thermal reactor.

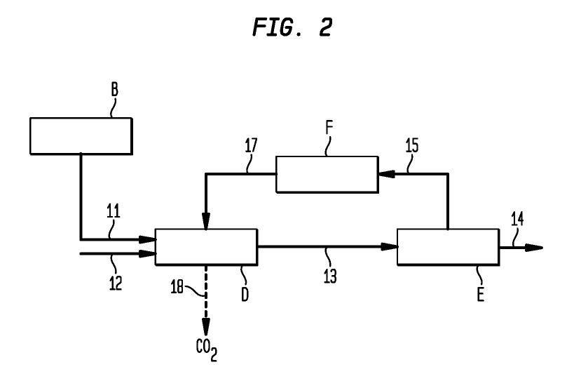

Turning to FIG. 2 which represents the discharge phase of the process, power is now needed. The carbon storage unit B will provide the solid carbon through line 11 and this solid carbon is fed along with air or oxygen through line 12 into a combustor or heat recovery steam generator (HRSG) labeled D.

The carbon is combusted thereby producing carbon dioxide which is recovered through line 18 and steam which is fed through line 13 to an engine or turbine E.

The engine or turbine will be driven by the steam to produce electricity through line 14. Low pressure steam will be removed through line 15 and fed to a heat recovery steam generator F which will recover heat from the low pressure steam and which will produce high pressure steam which can be fed through line 17 back into the combustor or heat recovery steam generator D.

If pure oxygen or an oxygen-rich gas is employed to burn the carbon in the combustion unit D, nearly pure carbon dioxide can be produced and recovered. Less pure carbon dioxide can be disposed of in an environmentally responsible manner while this nearly pure carbon dioxide can be employed as a saleable merchant product or used in other industrial applications such as enhanced oil recovery operations.

Compared to the electrolysis of water, methane decomposition requires 8 to 10 time less energy. This provides more economic utilization of the carbon and hydrogen as energy storage methods.

During the storage phase of the invention, excess electricity from the grid is utilized to produce the solid carbon and hydrogen gas. The carbon that is created can be stored in a storage tank while the hydrogen produced can be used as a chemical fuel.

At a later stage when electrical demand is high and power is required in the grid, the discharge phase begins and carbon is combusted in a stream of an oxygen-containing gas such as air to generate heat and subsequently steam which can be used in conventional devices such as boilers to generate electricity when require. The storage of solid carbon is simpler and less expensive than storing hydrogen for power generation using a fuel cell. Further, compared to electrolyzer based energy storage systems which only use hydrogen while oxygen is vented, similar efficiencies are achieved.

The advantages of the subject invention can be further understood by the following example and assumption based on usage of 1 kilo mole (16 kg) of methane as a sample hydrocarbon:
Methane cost: $0.26/kg ($5/MMbtu)
Hydrogen price: $3/kg
Electricity-buy: $0.05/KWH (solar power price at generation—conservative)
Electricity-sell: $0.07/KWH (at times of power demand—conservative)
Electrical Efficiency of converting methane to carbon & hydrogen: 70% (AHI has 75% actual efficiency)
Electrical Efficiency of converting carbon to CO₂ & power: 28% (conventional combustor)
% of credit of hydrogen sale to the energy storage concept: 25%
With these assumptions, the energy requirements are estimated as:
To convert 16 kg methane to 12 kg carbon and 4 kg hydrogen

| | | |
|---|---|---|
| Ideal energy required | KWH | 21.0 |
| Actual energy (electrical) | KWH | 29.9 |

To convert 12 kg carbon to 44 kg CO₂

| | | |
|---|---|---|
| Ideal energy released | KWH | 110.2 |
| Actual energy (electrical) | KWH | 30.9 |

And the corresponding revenues for the power sold to the grid are:

Revenues

| | | | |
|---|---|---|---|
| Power sales | KWH produced | 30.90 | $2.16 |
| H₂ credit | kg produced | 4 | $5.00 |
| Total revenue potential; | | | $7.16 |

To generate this revenue, on an operating basis, the following high level costs are required:
Costs

Operating - storage

| | | | |
|---|---|---|---|
| Methane | kg | 16 | $4.18 |
| Power | KWH used | 29.9 | $2.10 |

| | |
|---|---|
| Total operating costs - methane & power | $6.27 |

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for producing an energy source using excess electricity from a power grid comprising the steps:
a) feeding the excess electricity to a thermal reactor wherein solid carbon and gaseous hydrogen are produced from the thermal reaction of a hydrocarbon;
b) feeding the gaseous hydrogen to a hydrogen storage unit;
c) feeding the solid carbon to a carbon storage unit;
d) feeding the solid carbon from the carbon storage unit to a combustion unit wherein steam is produced; and
e) feeding the steam to a turbine thereby producing electricity.

2. The method as claimed in claim 1 wherein the solid carbon energy source is combusted.

3. The method as claimed in claim 1 wherein excess electricity from the power grid is an amount of electricity produced that is greater than the amount of electricity demand.

4. (canceled)

5. The method as claimed in claim 4 where the hydrocarbon is methane.

6. The method as claimed in claim 1 wherein the gaseous hydrogen is compressed before being fed to storage.

7. The method as claimed in claim 1 wherein the gaseous hydrogen is deployed in a method selected from the group consisting of car fueling, pipeline injection, and fuel cell for power generation.

8. The method as claimed in claim 7 wherein the gaseous hydrogen is combusted to produce electricity.

9. The method as claimed in claim 1 further comprising feeding an oxygen-containing gas selected from the group consisting of air, enriched air and oxygen to the combustion unit.

10. The method as claimed in claim 1 wherein the combustion unit is a heat recovery steam generator.

11. The method as claimed in claim 1 further comprising producing carbon dioxide in the combustion unit.

12. The method as claimed in claim 1 wherein the turbine produces low pressure steam which is fed to a second heat recovery steam generator.

13. The method as claimed in claim 12 wherein the second heat recovery steam generator feeds high pressure steam to the combustion unit.

14. (canceled)

15. The method as claimed in claim 1 further comprising feeding the steam to an engine to produce electricity.

16. A method for producing electricity using excess electricity from a power grid comprising the steps:
a) feeding the excess electricity to a thermal reactor wherein solid carbon and gaseous hydrogen are produced from the thermal reaction of a hydrocarbon;
b) feeding the gaseous hydrogen to a hydrogen storage unit;
c) feeding the solid carbon to a carbon storage unit;
d) feeding the solid carbon from the carbon storage unit to a combustion unit wherein steam is produced; and
e) feeding the steam to a turbine thereby producing electricity.

17. The method as claimed in claim 16 wherein excess electricity from the power grid is an amount of electricity produced that is greater than the amount of electricity demand.

18. (canceled)

19. The method as claimed in claim 18 where the hydrocarbon is methane.

20. The method as claimed in claim 16 wherein the gaseous hydrogen is compressed before being fed to storage.

21. The method as claimed in claim 16 wherein the gaseous hydrogen is deployed in a method selected from the group consisting of car fueling, pipeline injection, and fuel cell for power generation.

22. The method as claimed in claim 21 wherein the gaseous hydrogen is combusted to produce electricity.

23. The method as claimed in claim 16 further comprising feeding an oxygen-containing gas selected from the group consisting of air, enriched air and oxygen to the combustion unit.

24. The method as claimed in claim 16 wherein the combustion unit is a heat recovery steam generator.

25. The method as claimed in claim 16 further comprising producing carbon dioxide in the combustion unit.

26. The method as claimed in claim 16 wherein the turbine produces low pressure steam which is fed to a second heat recovery steam generator.

27. The method as claimed in claim 26 wherein the second heat recovery steam generator feeds high pressure steam to the combustion unit.

28. The method as claimed in claim 16 wherein the energy source is produced when electrical demand is low.

29. The method as claimed in claim 16 further comprising feeding the steam to an engine to produce electricity.
